(19) United States
(12) Patent Application Publication
(10) Pub. No.: US 2020/0271682 A1
(43) Pub. Date: Aug. 27, 2020

(54) Systems and Methods for Environmental Factor Interaction Characterization

(71) Applicant: Alpha Space Test and Research Alliance, LLC, Houston, TX (US)

(72) Inventors: Johnnie P. Engelhardt, West Columbia, TX (US); Kevin Heath, League City, TX (US)

(21) Appl. No.: 16/803,803

(22) Filed: Feb. 27, 2020

Related U.S. Application Data
(60) Provisional application No. 62/811,389, filed on Feb. 27, 2019.

(51) Int. Cl. G01N 35/04; G01N 35/00

(52) U.S. Cl. CPC G01N 35/04; G01N 2035/0405; G01N 35/00584

(57) ABSTRACT

An apparatus includes a housing, a sample carrier device. The sample carrier device includes samples and is mounted in the housing such that the samples are external to the housing. The apparatus further includes a sample cover mounted to the housing such that the sample cover and the housing enclose the sample carrier device. The apparatus further includes a sensor directed to the sample carrier device. The apparatus further includes a processor and a memory device storing instructions executable by the processor to initiate removal of the sample cover from the sample carrier device. The instructions are further executable by the processor to initiate capture of data by the sensor.

### CROSS-REFERENCE TO RELATED APPLICATIONS

This application claims priority to U.S. Provisional Application No. 62/811,389 filed Feb. 27, 2019, which is hereby incorporated by reference.

### BACKGROUND

During exploration of an environment, equipment (manned vehicles, autonomous vehicles, habitation systems, clothing, tools, etc.) is exposed to factors present in the environment. Such environmental factors may interact with the equipment and impede operation and/or damage the equipment. For example, on the surface of the Moon, lunar regolith may adhere to equipment and/or its constituent parts and materials. This lunar regolith may degrade the equipment through abrasion as the equipment moves. In addition, the lunar regolith may occlude sensors resulting in unreliable sensor data. Further, equipment exposed to lunar regolith and then transferred into a clean environment may contaminate the clean environment resulting in a health hazard for astronauts.

### SUMMARY

Various systems and methods for providing characterization of environmental factor interactions are described herein. These systems and methods may be used to characterize how one or more factors (e.g., materials, electromagnetic radiation, particle radiation, acoustic radiation, gravitational radiation, etc.) present in an environment interacts with various sample materials under test. This characterization may be used by designers to create equipment for deployment to an environment in which the one or more environmental factors are present.

An example system includes a module for deployment to an environment. The module includes a first sample carrier device and a second sample carrier device. Each sample carrier device includes one or more samples and one of the sample carrier devices is enclosed by a protective cover (e.g., a sample cover panel). Accordingly, one of the sample carrier devices may be exposed to the environment while one is shielded from the environment. Upon occurrence of a particular condition (e.g., passing of a period of time since the module has arrived in the environment), the example module is configured to remove the protective cover so that both sample carrier devices are exposed to the environment. The example module further includes cameras or other sensors to capture images of the sample carrier devices and/or other data to characterize the interactions of the samples with the environment. Accordingly, for example, accumulation of environmental material on samples of the sample carrier devices may be documented. Further, because the protective cover covers one of the sample carrier devices prior to occurrence of an event, images of the sample carrier devices or other data may be used to determine how much environmental interaction is due to a particular event or condition.

To illustrate, the example module may be deployed to the Moon and the sample cover may be removed at a time after impact of the module with the lunar surface. Accordingly, images of one of the sample carrier devices may depict lunar regolith accumulation due to impact and normal environmental exposure while images of the other sample carrier device may depict lunar regolith accumulation due solely to normal environmental exposure. Thus, data generated by the example module may be useful in designing equipment for deployment to the Moon or other environments.

### BRIEF DESCRIPTION OF THE DRAWINGS

For a detailed description of various examples, reference will now be made to the accompanying drawings in which:

FIG. 2 depicts an example of a system including a device for environmental factor interaction characterization.

FIG. 3 depicts a detailed view of external features of the device for environmental factor interaction characterization.

FIG. 4 depicts a view of internal features of the device for environmental factor interaction characterization.

FIG. 5 depicts details of camera mountings in the device for environmental factor interaction characterization.

FIG. 6 depicts example images that may be generated by the device for environmental factor interaction characterization.

FIG. 7 depicts an example method that may be performed by the device for environmental factor interaction characterization.

FIG. 8 depicts an example method for performing environmental factor interaction characterization.

FIG. 9 depicts examples of a sample mounting system in a device for environmental factor interaction characterization.

FIG. 10 depicts a block diagram of a device for environmental factor interaction characterization included within an external system.

FIG. 11 depicts a block diagram for environmental factor interaction characterization that includes an internal power supply and transceiver.

### DETAILED DESCRIPTION

Specific embodiments of the invention will now be described in detail with reference to the accompanying figures. In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Systems and methods for environmental factor interaction characterization are disclosed herein. These systems and methods may be used in various terrestrial and extraterrestrial environments to characterize how one or more environmental factors interact with one or more sample items under test.

As used herein, environmental factors include chemical or biological material present in an environment, electromagnetic radiation, particle radiation, acoustic radiation, gravitational radiation, and other factors present in an environment. Example environmental materials include regolith, soil, dust, salt, silt, or any other materials that may be present in a particular environment, including in the atmosphere.

As used herein, “sample” refers to an item monitored by the disclosed systems and methods for interactions with one or ore environmental factors. Samples may include material, coating, film, alloy, paint, electronic components, electronic system, electronic assembly, live or dead biological organisms, cells, tissue, fabric, aerogel, DNA, RNA, protein, plant, algae, virus, ceramic, nanomaterial, metamaterial, layups, composite, metal, polymer, fluid, glass, printed material, paper, foil, adhesive, chemical, solvent, charged surface, electromagnetic field, device, mechanism, nanomachine, quantum material, circuit, microfluidic device.

As used herein, “sample cover” refers to a panel or other shielding device configured to protect one or more samples from one or more environmental factors, such as contamination, dust, radiation of all kinds, particles, electromagnetic interference, light, liquids, gases, chemicals, charged particles, regolith, soil, etc. A sample cover may include a textile material, a ceramic material, a metal material, a semimetal material, an alloy material, any other suitable material, or a combination thereof. The disclosed systems and methods utilize one or more sensors to record data indicative of interaction between one or more samples under test and one or more environmental factors.

As used herein, “sensor” refers to a device configured to detect, identify or record an interaction of a component of the environment with a sample, or elements of the environment itself. Types of sensors can include but are not limited to camera, UV detector, IR detector, visible light detector, photometer, thermometer, dosimeter, mass spectrometer, voltmeter, ammeter, ohmmeter, barometer, microscope, pressure transducer, thermocouple, acoustic, microphone, magnetometer, accelerometer, seismometer, Hall probe, Faraday cup, Geiger counter, LIDAR, RADAR, SONAR, shock detector, colorimeter, photoresistor, photodiode, strain gauge, ph meter, motion detector.

In particular examples, the systems and methods are used to characterize how regolith adheres to sample materials exposed to an environment on a surface of an astronomical bodies (e.g., Earth; another planet, such as Mars; a moon, such as the Moon; a comet; an asteroid; etc.). In other particular examples, the systems and methods may be used to characterize how environmental materials (e.g., salt, silt, etc.) interact with sample materials in an aquatic environment.

Referring to FIG. 1, a diagram of a device 100 for environmental factor interaction characterization is shown. The device 100 includes a housing 102, a sample carrier device 104, a sample cover 106, a memory 108, a processor 110, a sensor 112, and an actuator 114. In some implementations, the housing 102 forms an airtight enclosure that protects internal components of the device 100. The housing 102 may include aluminum and/or other materials.

The sample carrier device 104 is mounted so that samples included in the sample carrier device 104 are external to the housing 102. In some implementations, the sample carrier device 106 is mounted to move (e.g., rotate) within the housing 102 to move the samples relative to the sensor 112. The sample included in the sample carrier device 104 are samples of various materials to be tested in an environment in which the device 100 is deployed. Examples of samples include aluminum, over glasses, suit materials, polymers, synthetic fibers, etc. The sample carrier device 104 is enclosed by the sample cover 106 and the housing 102. Accordingly, samples included in the sample carrier device 104 are projected from an external environment.

The sample cover 106 may include Nomex and/or other materials. The sample cover 106 is configured to be removed from the sample carrier device 104 by the actuator 114, thus exposing the samples of the sample carrier device 104 to an environment of the device 100. The actuator 114 includes a stepper motor, gears, a motor, an explosive bolt, or a combination thereof. In some implementations, the actuator 114 is further configured to replace the sample cover 106 over the sample carrier device 104 to re-enclose the samples of the sample carrier device 104.

The housing 102 further encloses a processor 110 and a memory 108. The memory 108 includes one or more computer readable storage devices such as random access memory, a read only memory, a flash memory, or another type of memory device. As used herein, a computer readable storage device refers to an article of manufacture and is not a transitory signal, The memory 108 stores instructions executable by the processor 110 to perform various operations and methods described herein, The processor 110 includes one or more microprocessors, one or more central processor units, one or more digital signal processors, one or more microcontrollers, one or more digital signal processors, one or more other processor devices, one or a combination thereof.

The sensor 112 is positioned to capture data related to the sample carrier device 104, such as sensor data associated with one or more samples included in the sample carrier device 104. In some implementations, the sensor 112 includes a camera, a spectrometer, an ultraviolet (UV) light sensor, a radiation sensor, a temperature sensor, another type of sensor, or a combination thereof.

In operation, the processor 110 executes instructions stored in the memory 108 to initiate removal of the sample cover 106 from the sample carrier device 104. For example, the processor 110 may initiate removal of the sample cover 106 responsive to a command from a remote device or in response to detection of an environmental condition. Example environmental conditions that may prompt the processor 110 to remove the sample cover 106 include passage of a particular amount of time since arrival of the device 100 in an environment, occurrence of a particular time, occurrence of a particular temperature, occurrence of a particular radiation level, etc.

The instructions are further executable by the processor 110 to initiate capture of data associated with the sample carrier device 104 by the sensor 112. For example, the processor 110 may cause a camera to capture an image of a particular sample of the sample carrier device 104.

The instructions are further executable by the processor 110 to initiate transmission of the sensor data to a remote device and/or to store the sensor data in the memory 108. For example, the processor 110 may initiate transmission of the captured image to a remote device (e.g., via a transceiver of the device 102 or a transceiver of a device linked to the device 102) responsive to a request from the remote device or responsive to occurrence of an environmental condition.

Thus, the device 100 may be used to generate sensor data characterizing how environmental factors interact with sample materials under test. Because the sample cover 106 shields the samples of the sample carrier device 104, interactions associated with particular events and/or conditions may be screened out of the data.

In an illustrative use case, the device 100 is deployed to a remote environment, such as the Moon. Upon impact with the lunar surface, the sample cover 106 protects the samples of the sample carrier device 104. Accordingly, regolith disturbed by the impact will not adhere to the samples. Subsequently, the sample cover 106 is removed by the actuator 114 responsive to a command from the processor 110 (e.g., issued in response to a command from a remote device). The processor 110 then initiates capture of image data associated with the samples in the sample carrier device 104 by the sensor 112. Because the sample cover 106 shielded the samples during the impact, any regolith accumulated on the samples in the image data is not a result of impact of the device 100.

In some implementations, the device 100 includes additional components. For example, the device 100 may include one or more additional sample carrier devices. In some such implementations, the device 100 includes a second sample carrier device that includes second samples which are duplicates of the samples of the sample carrier device 104. The second sample carrier device is unenclosed by the sample cover 106. Accordingly, the second samples of the second sample carrier device may be exposed to environmental factors while the samples of the sample carrier device 104 are shielded.

The sensor 112 may be configured to capture data associated with a single sample carrier device or multiple sample carrier devices. In some implementations, the sensor 112 is positioned external to the housing 102. In other implementations, the sensor is positioned internal to the housing 102. In some implementations, the device 100 includes sensors both inside and outside of the housing 102 and directed to the sample carrier device 104. In some implementations, each sample carrier device of the device 100 has one or more associated sensors internal to the housing and/or external to the housing. Aspects of various implementations described herein may be combined.

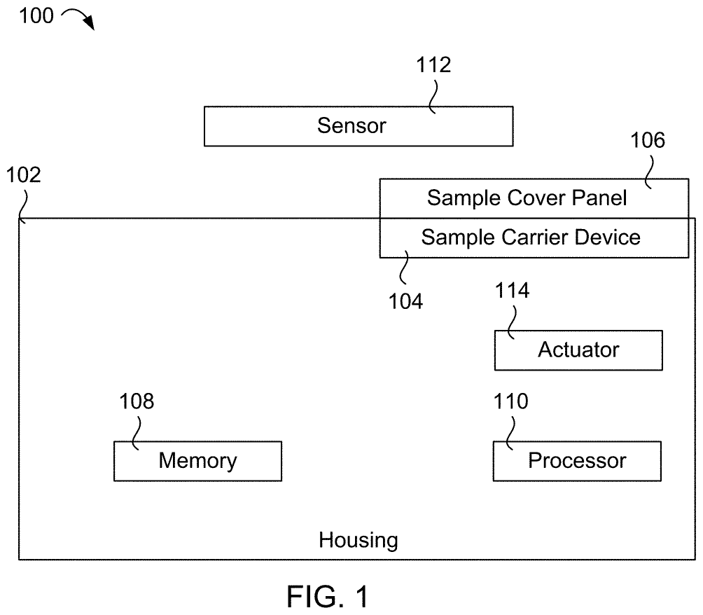

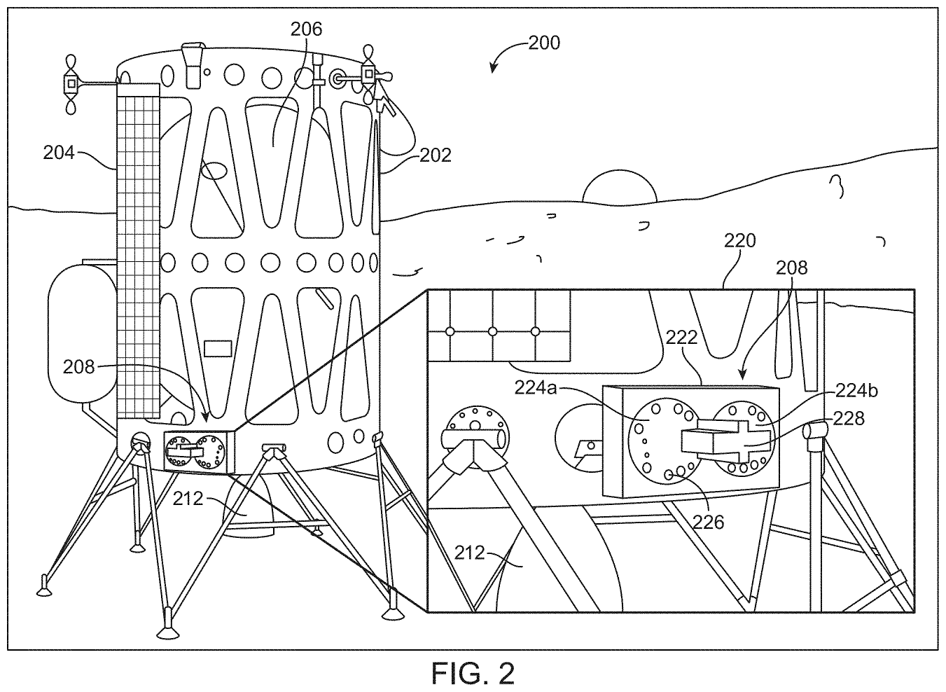

Referring to FIG. 2, an example of a device 208 for environmental factor interaction characterization is shown integrated into a landing vehicle 200. In other implementations, the device 108 is deployed by a robot. In the illustrated example of FIG. 2, the landing vehicle 200 includes a frame 202. Attached to the frame 202 is at least one photovoltaic panel 204 configured to generate electricity from light energy. While not depicted, the landing vehicle 200 may further include a battery configured to store the electricity generated by the photovoltaic panel 204. The landing vehicle 200 further includes a fuel tank 206 and a rocket thruster 212 (a nozzle of which is visible in FIG. 2) mounted to the frame 202. While not shown, the landing vehicle 200 further includes a transceiver (or individual transmitter and receiver) configured to transmit and receive data (e.g., to and from a control station on Earth).

The landing vehicle 200 is configured to be deployed to various environments (e.g., extraterrestrial astronomical bodies). A power supply (e.g., the photovoltaic panel 204 and the battery) of the landing vehicle 200 provides electrical power to modules of the landing vehicle 200. Further, the transceiver of the landing vehicle 200 is utilized by modules of the landing vehicle 200 to send and receive data. One such module configured to utilize the power supply and transceiver of the landing vehicle 200 is the device 208 for environmental factor interaction characterization. In other implementations, the power supply and the transceiver are provided by other infrastructure, such as a robot, or are incorporated into the device 108 itself.

The landing vehicle 200 further includes the device 208 for environmental or interaction characterization mounted within the frame 202. The device 208 for environmental factor interaction characterization may correspond to the device 100 of FIG. 1. As shown in close-up view 220, the device 208 includes a housing 222. The housing 222 may correspond to the housing 102 of FIG. 1. The housing 222 houses a first sample carrier 224a and a second sample carrier 224b. Alternative implementations include a different number of sample carrier devices. The second sample carrier device 224b may correspond to the sample carrier device 104 of FIG. 1. In the illustrated example, each of the sample carrier devices 224a, 224b includes a plurality of samples with a particular sample being designated 226. In some implementations, each of the sample carrier devices 224a, 224b carries 15 samples. Alternate examples include a different number of samples (e.g., one per sample carrier device). Examples of samples that may be included in the sample carrier devices 224a, 224b include aluminum or any other metal alloy, cover glasses, films, coatings, space suit materials, polymers, synthetic fibers, solar cells, electronic components and systems, biologics, etc. The sample carrier devices 224a, 224b each include the same types of samples.

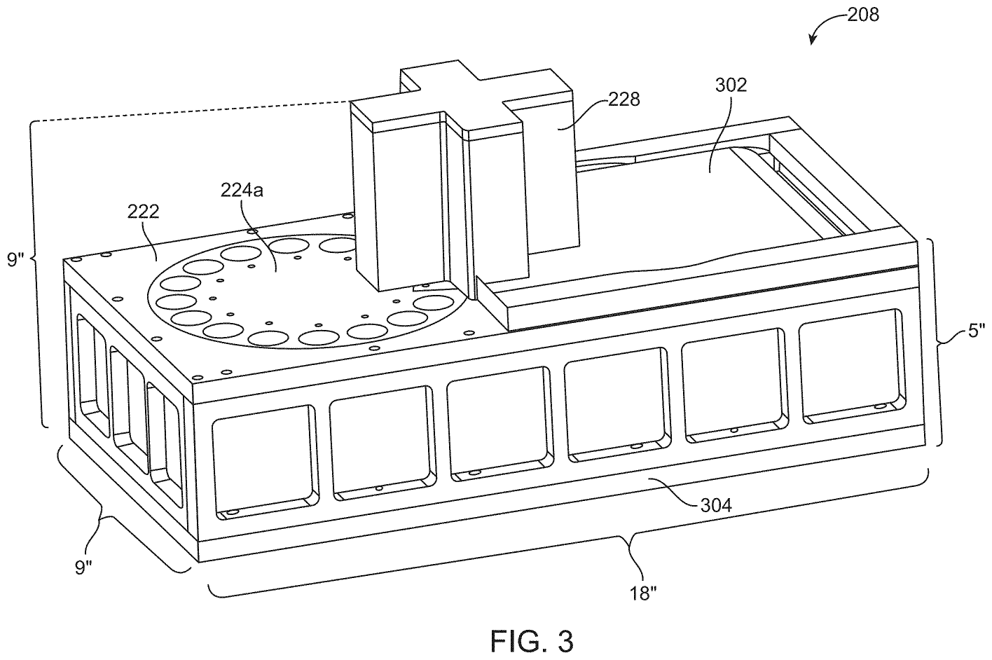

A camera enclosure 228 is mounted to the housing 222. As described further below, the device 208 is configured to manipulate the sample carrier devices 224a, 224b to move different samples included in the sample carrier devices 224a, 224b to one or more viewing areas of one or more cameras included in the camera enclosure 228 (e.g., underneath the camera enclosure 228) and/or within range of one or more other sensors, Details of an exterior of the device 208 for environmental factor interaction characterization are depicted from a different angle in FIG. 3.

In FIG. 3, the second sample carrier 224b is covered by a sample cover 302 (e.g., a sample cover panel or other device). In some implementations, the sample cover 302 comprises a fabric, such as Nomex, in a frame. The sample cover 302 may correspond to the sample cover 106 of FIG. 1. As described further herein, the device 208 for environmental factor interaction characterization may be deployed with the sample cover 302 covering the samples of the second carrier 224b and then the sample cover 302 may be removed (e.g., by the device 208) after deployment. The device 208 further includes an interface 304 for connecting to the lander landing vehicle 200. The interface 304 includes a communication interface (e,g., a RS-422 connector or other connector) and a power connector.

In the illustrated example, a height of the device 208 from the interface 304 to a face of the camera enclosure 228 is nine inches while a combined height of the enclosure 222, the sample cover 302 and the interface 304 is five inches. A length of the device 208 is depicted as eighteen inches and a width of the device 208 is depicted as nine inches. Other examples of devices for environmental factor interaction characterization according to the disclosure may have different dimensions.

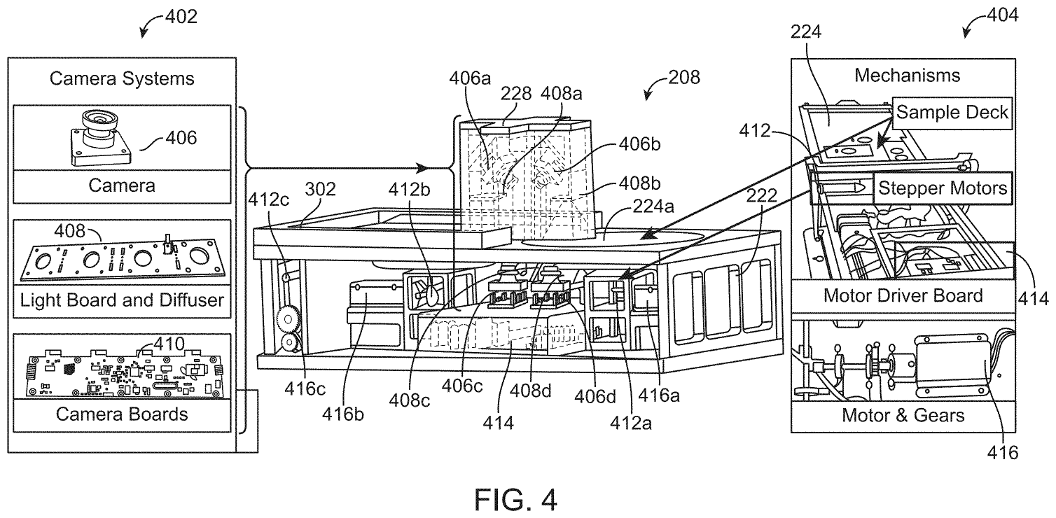

Referring to FIG. 4, a diagram showing internal components of the device 208 for environmental factor interaction characterization is shown. As shown, the camera enclosure 228 includes a first top camera 406a and a second top camera 406b. The device 206 further includes a first bottom camera 406c and a second bottom camera 406d, In the illustrated example, the first top camera 406a and the second bottom camera 406d correspond to (e.g., are arranged to capture images of) the first sample carrier 224a and the second top camera 406b and the first bottom camera 406c correspond to the second sample carrier 224b. The second top camera 406d, the first bottom camera 306c or a combination thereof may correspond to the sensor 112 of FIG. 1. The top cameras 406a, 406b are configured to capture images of surfaces of the sample carrier devices 224a, 224b external to the housing 222 (e.g., that may be exposed to an external environment) while the bottom cameras 406c, 406d are configured to capture images of surfaces of the sample carrier devices internal to the housing 222. In some implementations, the cameras 406a, 406b, 406c, 406d are replaced by or supplemented with spectrometers and/or other sensors. The sensor 112 of FIG. 1 may correspond to such a spectrometer.

The device 206 further includes lighting devices 408a, 408b, 408c, 408d. A first lighting device 408a is arranged within the camera enclosure 228 and configured to project light onto the external surface of the second sample carrier 224b, and a second lighting device 408b is arranged within the camera enclosure 228 and configured to project light onto the external surface of the first sample carrier 224a. The camera enclosure 228 is configured to shield a portion of the sample carrier devices 224a, 224b from external light sources. A third lighting device 408c is arranged within the housing 222 and configured to project light onto the internal surface of the second sample carrier 224b, and a third lighting device 408d is arranged within the housing 222 and configured to project light onto the internal surface of the first sample carrier 224a.

Zoom view 402 shows close up view of an example camera 406 that may correspond to one of the cameras 406a, 406b, 406c, 406d. In some examples, the cameras 406a, 406b, 406c, 406d correspond to Basler® dart cameras (Basler is a registered trademark of Basler AG of Ahrensburg, Germany). In other examples, the cameras 406a, 406b, 406c, 406d correspond to a different type of camera. In some implementations, the cameras are configured to capture images of particles or sample variations as small as 20 microns or less.

Zoom view 402 further shows an example of a light board and diffuser 408 that is incorporated into the lighting devices 408a, 408b, 408c, 408d. In some implementations, the diffuser includes four diffused light emitting diode (LED) lights. In some examples, the lighting devices 408a, 408b, 408c, 408d are configurable by the device 208 to output light at different frequencies. While not illustrated, the camera enclosure 228 further include electrostatic filters in some implementations. In such implementations, each electrostatic filter includes a positively charged plate and an opposite negatively charged plate extending into the camera enclosure 228 from a base of the camera enclosure 228. The electrostatic filters are thus configured to attract particles (e.g., regolith) that enter the camera enclosure 228 and protect the cameras 406a, 406b and the lighting devices 408a, 408b. Each of the cameras 406a, 406b may have an associated positive/negative plate pair. The zoom view 402 further depicts an example camera board 410. In some implementations, each of the cameras 406a, 406b, 406c, 406d has an associated camera board that includes circuitry configured to support camera operations. Such a camera board may include an interface configured to transmit data to and from a computing device (not shown) of the device 208.

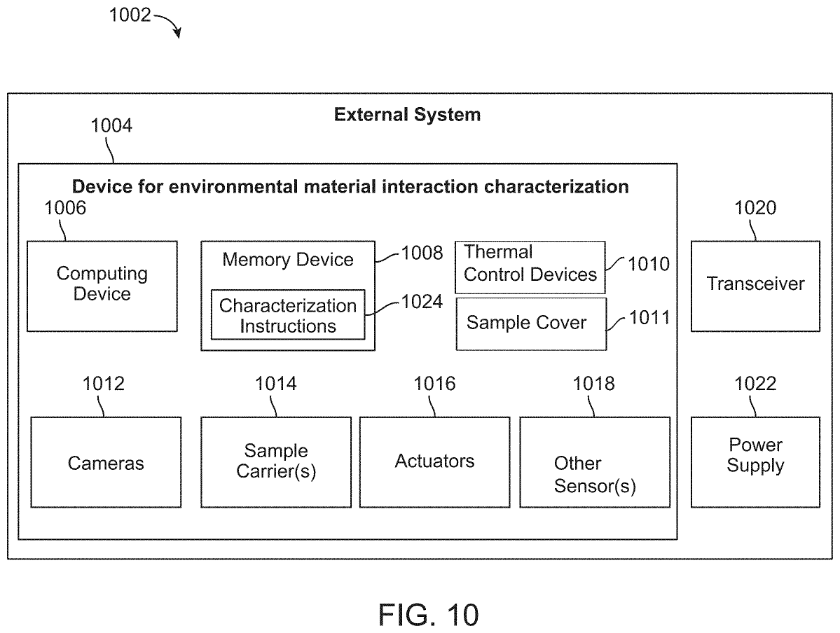

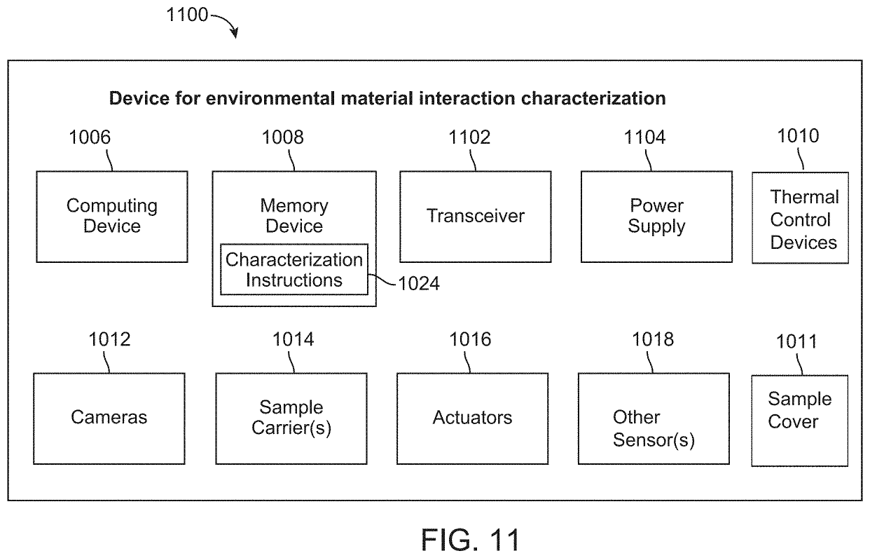

The device 208 further includes a first stepper motor 412a configured to rotate the first sample carrier 224a to reposition samples of the first sample carrier 224a relative to the second top camera 406b and the second bottom camera 406d. The device 208 further includes a second stepper motor 412b configured to rotate the second sample carrier 224b to reposition samples of the second sample carrier 224b relative to the first top camera 406a and the first bottom camera 406c. The device 208 further includes a third stepper motor 412c configured to move the sample cover 302 relative to the housing 222. The stepper motors 412a, 412b, 412c are each associated with corresponding motors and gears 416a, 416b, 416c configured to drive the stepper motors 412a, 412b, 412c responsive to signals from a motor driver board 414 included in the housing 222. The third stepper motor 412c, the third motor and gears 416c, or a combination thereof may correspond to the actuator 114 of FIG. 1. The motor driving board 414 is connected to and responsive to commands from a computing device within the device 208 (described further below with reference to FIGS. 10 and 11). In other implementations, the stepper motors y be replaced with other actuator types and the sample carrier rotation replaced with other motion or no motion at all.

Zoom view 404 further shows an illustrative example of a sample carrier 224. Each of the sample carrier devices 224a, 224b may have a configuration similar to the example sample carrier 224. The zoom view 404 further depicts an example stepper motor 412. Each of the stepper motors 412a, 412b, 412c may have a configuration similar to the example stepper motor 412. The zoom view 404 further depicts an example of a motor and gears 416. Each of the motor and gears 416a, 416b, 416c may have a similar configuration to the example motor and gears 416.

The device 208 is configured to be deployed to a remote location (e.g., a remote astronomical body, an active volcano, an ocean, etc.). The device 208 is further configured to activate the stepper motors 222a, 222b to drive particular samples within view ranges of the cameras 406a, 406b, 406c, 406d. Other implementations drive the cameras 406a, 406b, 406c, 406d within range of stationary samples, The device 208 is further configured to generate images of the samples in the sample carrier devices 224a, 224b. The device 208 is further configured to transmit the images (e.g, using the transceiver of the vehicle 200) to a remote device (e.g., a control station on Earth). Because the samples of the sample carrier devices 224a, 224b are exposed to an external environment, a user of the remote device may be able to ascertain a rate at which environmental factors of the remote location interact with (e.g., a rate at which environmental material adheres to) the samples within the sample carrier devices 224a, 224b based on the images.

The sample cover 302 shields the samples of the second sample carrier 224b until the sample cover 302 is removed. The device 208 (e.g., a computing device within the device 208) is configured to signal the motor driver board 414 to initiate actuation of the third stepper motor 412c via the third motors and gears 416c in response to receiving (e.g., via the transceiver of the vehicle 200) an instruction to remove the sample cover 302 or in response to the device 208 detecting a removal condition. Example removal conditions include arrival of the device 208 in a target environment, occurrence of a target temperature range, occurrence of a target pressure range, occurrence of a target time (e.g., 24 hours after landing), etc. The device 208 may detect the removal condition based on data from the cameras 406a, 406b, 406c. 406d, based on data from one or more other sensors (described further below), or a combination thereof. Accordingly, the images of the samples of the second sample carrier device 224b generated by the device 208 may depict accumulation of environmental materials following removal of the sample cover 302. Images of the samples, or other data from the samples, may be collected overtime such that a determination can be made as to how environmental materials interact with samples under test over time. By selecting materials for use in the tested environment based on the data describing how environmental factors interact with samples under test over time, equipment designers may extend life of systems, sub systems, and components; improve operations, reliability, and performance; and lower risk of failure, operations risk, and logistical and life cycle cost.

In some implementations, the device 208 (e.g., a computing device within the device 208) is configured to signal the motor driver board 414 to initiate actuation of the third stepper motor 412c via the third motors and gears 416c to cover the second sample carrier device 224b in response to receiving (e.g., via the transceiver of the vehicle 200) an instruction to replace the sample cover 302 or in response to the device 208 detecting a cover condition. Example cover conditions include time of day, temperature, radiation levels, pressure levels, etc.

In an example use case, the vehicle 200 is deployed to the lunar surface. Upon impact with the lunar surface, the samples of the first sample carrier device 224a are exposed to lunar regolith while the samples of the second sample carrier device 224b are shielded. After impact, a control center signals the device 208 to remove the sample cover 302. Accordingly, the device 208 signals the motor driver board 414 to initiate the stepper motor 412c to drive the sample cover 302 from the second sample carrier device 224b. The control center then periodically signals the device 208 to generate image data of the samples in the sample carrier devices 224a, 224b. Upon receiving such a signal, the device 200 signals the driver board 414 to activate the first stepper motor 412a to drive the first sample carrier device 224a to position a first sample within the camera enclosure 228. The device 200 further signals the driver board 414 to activate the second stepper motor 412b to drive the second sample carrier 224b to position a corresponding first sample within the camera enclosure 228. The device 200 then initiates capture of images of the first samples from above and below using the cameras 406a, 406b, 406c, 406d. The device 208 sends the captured images to the control center (e.g., via the transceiver of the vehicle 200). The device 208 repeats this process for each sample. Accordingly, a user at the remote control station may compare lunar regolith accumulation in samples exposed to lunar impact and samples shielded from lunar impact.

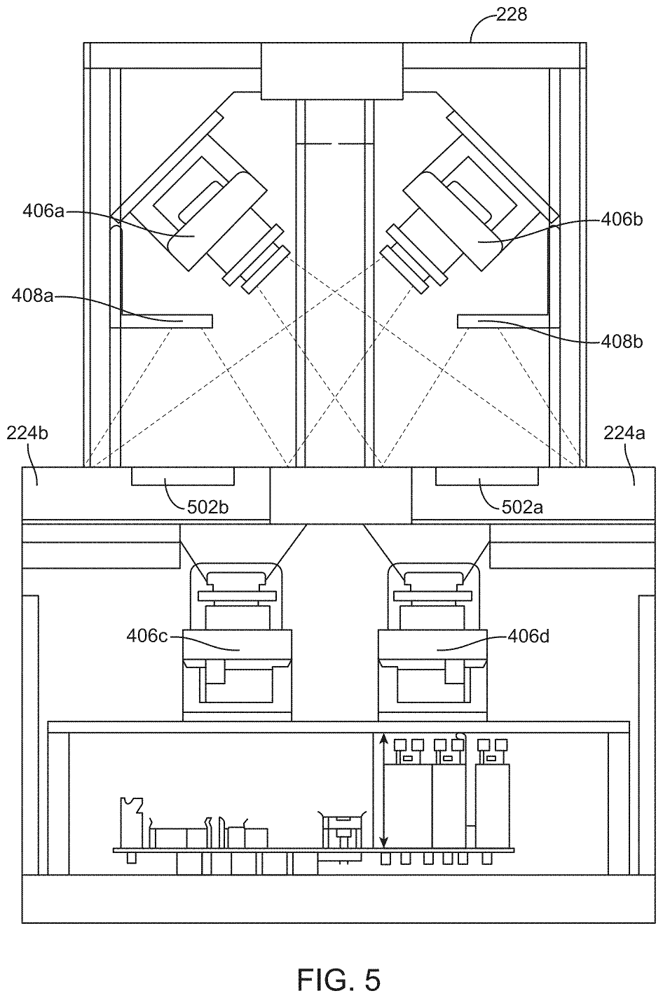

Referring to FIG. 5, an illustration of a configuration the cameras, 406a, 406b, 406c, 406d of the device 208 for environmental factor interaction characterization is shown. In the illustrated example, a first sample 502a of the first sample carrier device 224a and a second sample 502b of the second sample carrier device 224b are arranged within the camera enclosure128. The top cameras 406a, 406b are each oriented at a 45 degree angle with respect to the sample carrier devices 224a, 224b. While a 45 degree angle is depicted, the top cameras 406a, 406b are mounted at other angles in other examples. Mounting the cameras 406a, 406b at angles other than 90 degrees with respect to the sample carrier devices 224a, 224b may cause images of samples captured by the cameras 406a, 406b to depict a height of environmental material deposits on the samples. In some implementations, the device 208 includes motors that are controllable by the device 208 (e.g., by a computing device of the device 208) to manipulate mounting angles of the cameras 406a, 406b. The device 208 may activate such motors to bring the cameras 406a, 406b to a target angle (e.g., 45 degrees) making the device 208 more robust to impacts that may jostle the cameras 406a, 406b. Further, in such implementations, the device 208 may activate the motors to bring the cameras 406a, 406b to a variety of angles at which the device 208 may initiate capture of images.

The camera enclosure 228 shields the samples 502a, 502b within the camera enclosure 228 from external light which reduces glare in images captured by the cameras 406a, 406b, 406c, 406d. Further the lighting devices 408a, 408b, 408c, 408d provide even lighting above and below the samples 502a, 502b. Accordingly, the images captured by the cameras 406a, 406b, 406c, 406d may be more easily interpreted.

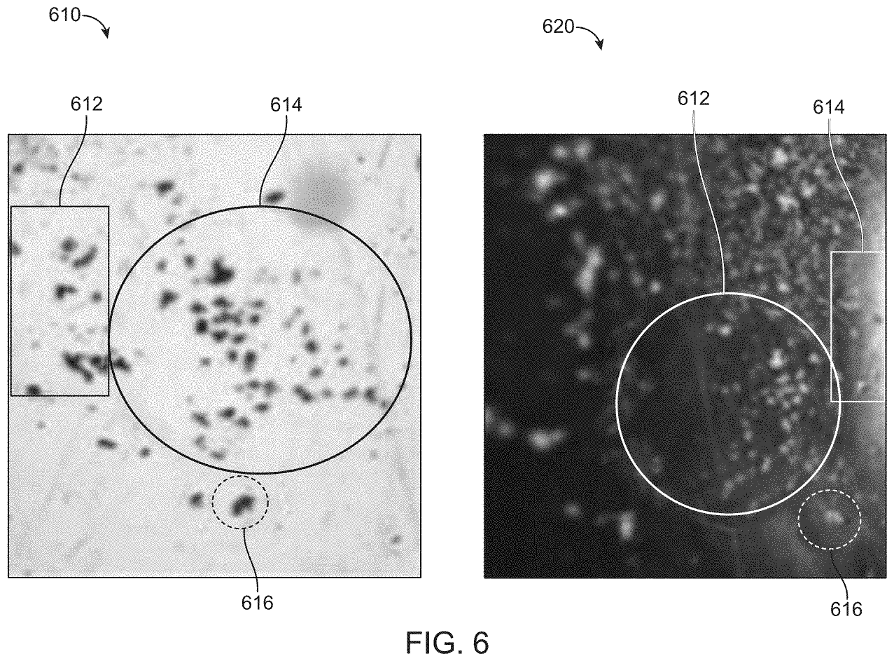

FIG. 6 depicts examples of images that may be captured by the cameras 406a, 406b, 406c, 406d. In particular. FIG. 6 illustrates a first image 610 and a second image 620. The first image 610 is an image captured from beneath a sample (e.g., the first sample 502a or the second sample 502b) by a bottom camera (e.g., the first bottom camera 406c or the second bottom camera 406d). The first image 610 corresponds to a “shadowgraph” of material that is deposited on the sample. The shadowgraph depicts shadows caused by environmental material preventing light from penetrating the sample. The second image 620 is an image captured from above the sample by a top camera (e.g., the first top camera 406a or the second top camera 406b). The second image 620 depicts accumulation of environmental material on a surface of the sample exposed to an external environment. The images 610, 620 include three highlighted regions 612, 614, 616 of the sample.

The device 208 may have alternate configurations. In such alternate configurations, the device 208 may include more or fewer components. For example, in the illustrated example described above, the components of the device 208 draw power from the battery of the vehicle 200 and the device 208 utilizes a transceiver of the vehicle 200. In some implementations, the device 208 includes a direct current (DC) to DC converter to convert electricity from the vehicle 200 from one voltage to a voltage supported by the device 208. In some examples, the device 208 includes an internal power source (e.g., a battery, a photoelectric panel, another power source, or a combination thereof) rather than or in addition to utilizing the power supply of the vehicle 200. Further, in some examples, the device 208 includes a transceiver rather than or in addition to utilizing the transceiver of the vehicle 200. In some implementations, the sample cover 302 is attached to a different removal mechanism than shown (e.g., in place of the third stepper motor 412c). For example, the sample cover 302 may be coupled to an explosive bolt activatable by the device 208. In some implementations, the device 208 includes one or more survival heaters configured to warm components of the device 208. Such survival heaters may include a patch heater, a radioisotope heater unit, another heater device, or a combination thereof. In some examples, the device 208 includes a different number of sample carrier devices than shown and includes a top camera and a bottom camera corresponding to each sample carrier device. Further, while not depicted, in some examples the device 208 includes additional or alternative sensors, such as a temperature sensor, an ultraviolet (UV) sensor, a radiation sensor, a different type of sensor or a combination thereof associated with each of the sample carrier devices 224a, 224b. The sensor 112 of FIG. 1 may correspond to such a temperature sensor, UV sensor, radiation sensor, or combination thereof.

Further in some implementations, the device 208 includes a different number of sample carrier devices (e.g., 1 or more than 2) and/or a different number of cameras (e.g., 0 or a number other than 4) and/or the cameras are oriented differently. For example, a single camera may be positioned to capture images of more than one sample carrier device.

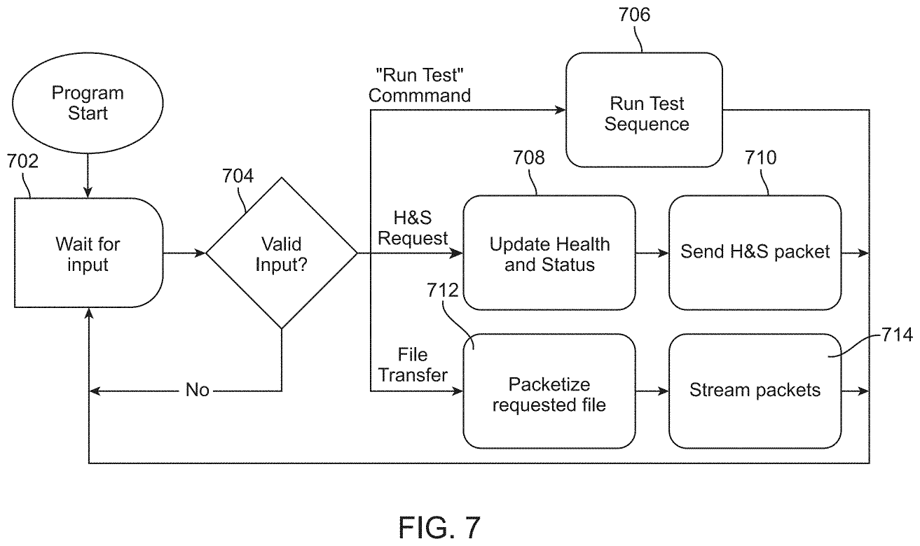

Referring to FIG. 7, a method 700 that may be performed by the device 208 for environmental factor interaction characterization is shown. In particular, the method 700 may be performed by a computing device of the device 208 for environmental factor interaction characterization, The method 700 includes waiting for input, at 702. For example, the device 208 may wait for input from the vehicle 200. Such input may be generated by the vehicle 200 based on one or more signals received via the transceiver of the vehicle 200. In some implementations, the input is formatted according to the RS-422 format.

The method 700 further includes determining whether valid input has been received, at 704. In response to determining that no valid input has been received, the method 700 includes continuing to wait for input, at 702. For example, the device 208 may continue waiting for input in response to invalid input from the vehicle 200 or response to receiving no input from the vehicle 200.

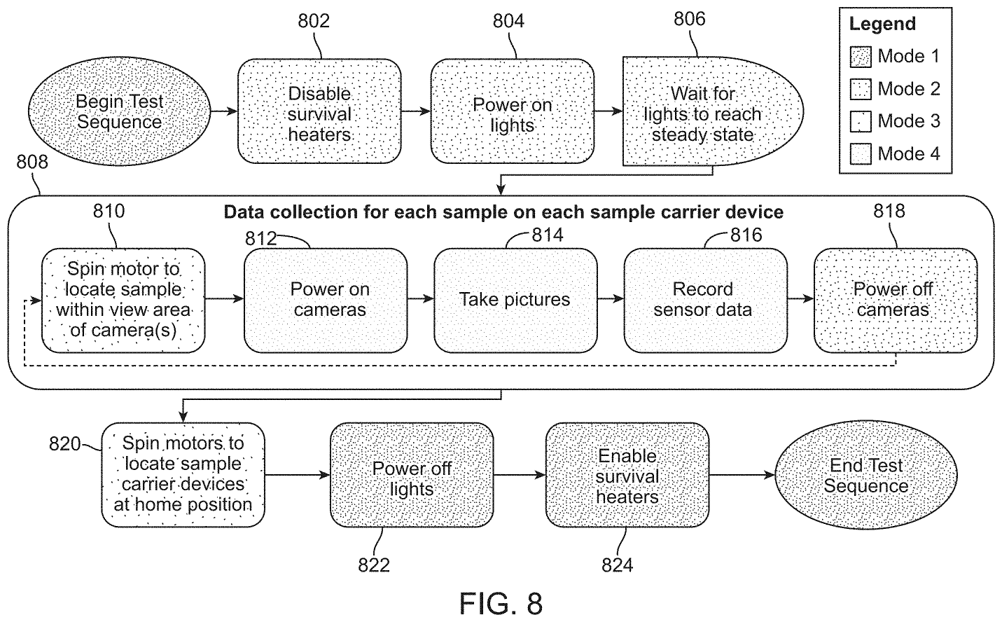

In response to receiving valid input indicating a “Run Test” command has been received, the method 700 further includes running a test sequence, at 706. and continuing to wait for additional input, at 702. For example, the device 208 may initiate capture of images of the samples in the sample carrier devices 224a, 224b and other sensor data in response to a command to initiate a test sequence. A method of performing the test sequence is described further below with reference to FIG. 8.

In response to receiving valid input indicating a “Health and status” command has been received, the method 700 generating health and status data, at 708. For example, the device 208 may determine health and status data including current draw, internal temperature of the device 208, connectivity, radiation levels proximate the device 208, memory usage of the device 208, some other status, or a combination thereof.

The method 700 further includes sending a health and status packet to the vehicle 200 for transmission, at 710. For example, the device 208 may transfer a packet including the health and status data to the vehicle 200 for transmission to a remote control center.

In response to receiving valid input indicating a “file transfer” command, the method 700 includes packetizing the requested file, at 712. For example, the device 208 may receive input from the vehicle 200 requesting a file (including, for example, one or more images, other sensor data, or a combination thereof). The device 208 may packetize the requested file into one or more data packets. In some implementations, the device 208 packetizes the requested file according to the Consultative Committee for Space Data Systems (CCSDS) file delivery protocol.

The method 700 further includes streaming packets, at 714, and continuing to wait for input, at 702. For example, the device 208 may stream the one or more data packets to the vehicle 200 for transmission to the remote command center and then continue to wait for additional input.

While some aspects of the method 700 are described as performed responsive to input commands, it should be noted that such aspects may be performed in response to other conditions as well. For example, the method 700 may be modified such that the test sequence is run, at 706, in response to expiration of a periodic timer (e.g., every 24 hours). Similarly, a modified version of the method 700 may include generating and sending health and status update packets in response to expiration of a periodic timer and/or streaming data packets for transmission in response to expiration of a periodic timer. Other conditions that may trigger running a test sequence, a health and status packet, or a data packet transmission include environmental conditions. For example, a modified version of the method 700 may include running the test sequence, generating and sending the health and status packet, generating and sending the data packets, or a combination thereof in response to a determination that an environmental factor (e.g., ambient radiation, illumination, pressure, temperature, etc.) satisfies a threshold. In some implementations, a modified version of the method 700 includes performing an analysis of image and sensor data captured in the test sequence. For example, the device 208 may perform image analysis and/or sensor data analysis to characterize (e.g., assign a rating describing) interaction of each sample in the sample carrier devices 224a, 224b with one or more environmental factors based on image data and sensor data captured during the test sequence.

The method 700 may further include additional steps for example, the method 700 may include removing a sample cover in response to input indicating a remove sample cover command. To illustrate, the device 208 may initiate removal of the sample cover 302 from the second sample carrier device 224b in response to input indicating a removal command. The method 700 may further include replacing the sample cover by activating the third stepper motor 412c in response to input indicating a replace sample cover command. To illustrate, the device 208 may initiate replacement of the sample cover 302 over the second sample carrier device 224b by activating the third stepper motor 412c in response to input indicating a replace command. It should be noted that the method 700 may include removing and/or replacing the sample cover automatically in response to detecting particular events. For example, the device 208 may initiate removal of the sample cover 302 in response to detecting that a period of time has passed since an event (e.g., impact of the device 208 with another body, such as the Moon). As other examples, the device 208 may initiate removal of the sample cover 302 in response to detecting particular environmental conditions (e.g., temperature, radiation, UV exposure, some other condition, or a combination thereof) that satisfy a threshold. Similarly, the device 208 may automatically replace the sample cover 302 in response to detecting various conditions.

Referring to FIG. 8, a flowchart illustrating details of a method 800 of running the test sequence, at 706, of the method 700 are shown. The method 800 includes disabling survival heaters, at 802. For example, the device 208 may shut down its survival heaters upon beginning a test sequence (e.g., to manage power consumption).

The method 800 further includes powering on lights, at 804. For example, the device 208 may activate the lights 408a, 408b, 408c, 408d. The method 800 further includes waiting for lights to reach a steady state, at 806. For example, the device 208 may wait for a period of time associated with an estimated time for the lights 408a, 408b, 408c, 408d to obtain a steady state. This period of time (e.g., several seconds to several minutes) may be stored in a memory of the device 208.

The method 800 further includes collecting data for each sample on each sample carrier device, at 808. Collecting data for a sample, at 808, includes spinning a motor to locate the sample within a view area of one or more cameras, at 810. For example, the device 208 may activate the motor and gears 416a (or the motor and gears 416b) to drive the first stepper motor 412a (or the second stepper motor 412b) to rotate the first sample carrier device 224a (or the second sample carrier device 224b) and bring a particular sample (e.g., the first sample 502a or the second sample 502b) within the camera enclosure 228. In some implementations, the device 208 includes different actuator types to rotate the sample carrier devices. Further, in some implementations of the method 800, one or more sensors are moved relative to stationary samples.

Collecting data for a sample, at 808, further includes powering on cameras, at 812. For example, the device 208 may power on the first top camera 406a and the second bottom camera 406d (or the second top camera 406b and the first bottom camera 406c). Collecting data for a sample, at 808, further includes capturing images, at 814. For example, the device 208 may initiate capture of images of the particular sample by the first top camera 406a and the second bottom camera 406d (or the second top camera 406b and the first bottom camera 406c), In devices that include spectrometers or other sensors in place of cameras, the method 800 may include powering on the spectrometers and/or other sensors in place of powering on cameras, at 812, and taking spectrometer and/or other sensor readings, at 814, in place of taking pictures. In devices that include spectrometers and/or other sensors in addition to cameras, collecting data for a sample, at 808, may additionally include powering on the spectrometers and/or other sensors and initiating capture of spectrometer data and/or other sensor readings in addition to powering on cameras and initiating capture of images.

Collecting data for a sample, at 808, further includes recording sensor data, at 816. For example, the device 208 may record radiation data, UV light data, temperature data, other data, or a combination thereof associated with the particular sample using a radiation sensor, a UV sensor, a temperature sensor or a combination thereof onboard the device 208.

Collecting data for a sample, at 808, further includes powering off the cameras, at 818. For example, the device 208 may power off the first top camera 406a and the second bottom camera 406d (or the second top camera 406b and the first bottom camera 406c). In implementations that include additional or alternative sensors, the method 800 includes powering down the additional or alternative sensors in place of or in addition to powering down the cameras.

The method 800 includes collecting data for a sample, at 808, for each sample included in the sample carrier devices of a device for characterizing environmental factor interaction. For example, collecting data for a sample, at 808, may be performed by the device 208 for each sample in each of the sample carrier devices 224a, 224b. In some implementations, collecting data for a sample, at 808, may be performed in parallel at each sample carrier device in a device for characterizing environmental factor interaction. For example, collecting data for a sample, at 808, may be performed by the device 208 in parallel at each of the sample carrier devices 224a, 224b.

The method 800 further includes spinning the motors to locate the sample carrier devices at home position, at 820. Home position indicates defines the spatial relationship between each sample and sensor necessary for data collection, such as photographic images. For example, the device 208 may activate the motor and gears 416a and the motor and gears 416b to drive the first stepper motor 412a and the second stepper motor 412b to rotate the first sample carrier device 224a and the second sample carrier device 224b to home positions. In the home positions, all samples in the sample carrier devices 224a, 224b are located outside of the camera enclosure 228 and bring a particular sample (e.g., the first sample 502a or the second sample 502b) within the camera enclosure 228, placing the particular sample in a position for a photograph or other data collection.

The method 800 further includes powering off the lights, at 822. For example, the device 208 may power off the lights 408a, 408b, 408c, 408d. The method 800 further includes enabling the survival heaters, at 824. For example, the device 208 may activate its survival heaters.

Thus, a device for characterization of environmental factor interaction may perform the method 800 to capture images (and sensor data) for all samples in sample carrier devices of the device for characterization of environmental factor interaction and return to an idle state In some examples, the method 800 further includes initiating transmission of the captured image and sensor data to a remote device. For example, the device 208 may initiate transmission of captured image and sensor data to a remote device automatically upon completing data collection. In some examples, a modified version of the method 800 includes manipulating a sample under test prior to taking the pictures, at 814, and recording the sensor data, at 816. For example, the device 208 may set frequencies of the lighting devices 408a, 408b, 408c, 408d, apply an electric current to the sample, bring the sample to a particular temperature, or a combination thereof.

Steps of the method 800 are depicted as corresponding to various power consumption modes. Each of the modes consumes less power than a maximum power (e.g., 8 watts) available to a device performing the method 800. The maximum power available to the device performing the method 800 may correspond to a power output limit of a power supply of an external system (such as the vehicle 200).

In a “Mode 1,” a processor, sensor devices (e.g., radiation, UV sensors, temperature sensors), and survival heaters are active. In a “Mode 2,” the processor, the sensor devices, lights, and heaters are active. In the “Mode 3,” the processor, the sensor devices, the lights, and a motor are active. In the “Mode 4,” the processor, the sensor devices, the lights, and cameras are active. The method 800 may begin in the “Mode 1” and steps 822 and 824 may correspond to the “Mode 1,” The steps 802, 804, 806, 818 may correspond to the “Mode 2.” The steps 810, 820 may correspond to the “Mode 3.” The steps 812, 814, 816 may correspond to the “Mode 4.” In different implementations of the method 800, the steps of the method 800 may correspond to different power consumption modes. Further, the method 800 may include fewer steps or steps arranged in a different sequence based on power consumption requirements of a device.

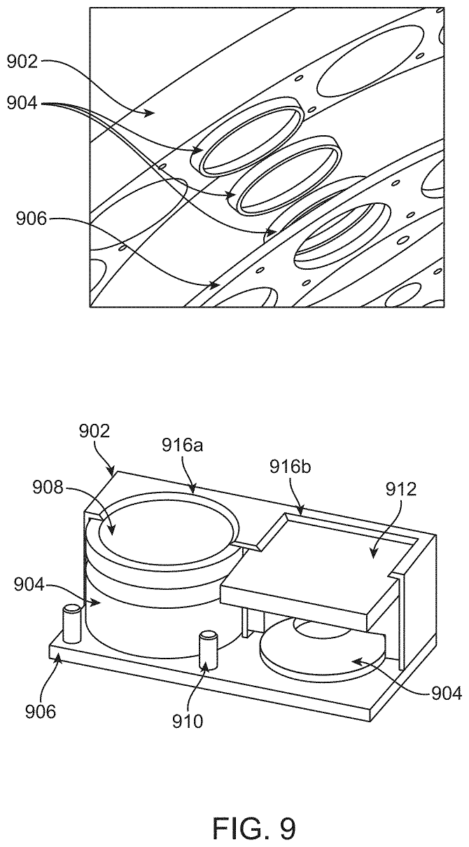

Referring to FIG. 9, a detailed illustration of a mounting system 900 within a sample carrier device, such as the sample carrier devices 224a, 224b, is shown. The mounting system includes an external deck plate 902 and a retainer deck 906. In the external deck plate 902 a plurality of openings 916 are formed. These openings may be circular, square, another shape, or a combination thereof. The external deck plate 902 is exposed to an exterior of the housing 222 while the retainer deck 906 is located within the housing 222. The retainer deck plate is secured by screws 910 to the external deck plate 902.

The openings 916 have smaller dimensions (e.g., length, width, diameter, etc.) as compared to the corresponding samples. FIG. 9 depicts an example circular opening 916a corresponding to a circular sample 908 and an example square opening 916b corresponding to an example square sample 912. In between the decks 902, 906, washers 904 are placed to secure samples between the decks 902, 906. Because the openings 916 are smaller than the samples, and the washers 904 hold the samples against the external deck plate 902, environmental material may be prevented from entering the housing 222.

Referring to FIG. 10, a block diagram illustrating a system 1000 including a device 1004 for environmental factor interaction characterization is shown. In the example shown in FIG. 10, the device 1004 is included within an external system 1002. The external system 1002 may correspond to the vehicle 200 or to another system. Similarly, the device 1004 may correspond to the device 208 and/or to the device 100.

The device 1004 for environmental factor interaction characterization includes a computing device 1006. The computing device 1006 corresponds to one or more microprocessors, one or more central processor units, one or more digital signal processors, one or more microcontrollers, one or more digital signal processors, one or more other processor devices, one or a combination thereof.

The device 1004 further includes a memory device 1008. The memory device 1008 is a computer readable storage device and includes one or more random access memory devices, one or more hard disc drive devices, one or more flash memory devices, one or more other memory devices, or a combination thereof. As used herein, a computer readable storage device refers to an article of manufacture and is not a transitory signal. The memory device 1008 stores characterization instructions 1024 executable by the computing device 1006 to perform the method or operations described herein.

The device 1004 further includes one or more thermal control devices 1010, such as survival heaters. The one or more thermal control devices 1010 include one or more patch heaters, one or more radioisotope heater units, one or more other heater devices, thermal electric coolers, or a combination thereof. The thermal control devices 1010 may correspond to the survival heaters deactivated in the method, at 802.

The device 1004 further includes one or more cameras 1012. The cameras 1012 include USB3 Vision® standard compliant cameras and/or other types of cameras, The cameras 1012 may correspond to the cameras 406a, 406b, 406c, 406d and/or to the sensor 112. The cameras 1012 are configured to capture images responsive to commands from the computing device 1006. Image data generated by the cameras 1012 is stored in the memory device 1008 in some implementations. In some implementations, the cameras 1012 are replaced by or supplemented with spectrometers and/or other sensors.

The device 1004 further includes one or more sample carriers 1014. The sample carriers 1014 are configured to carry one or more sample materials on an outside surface of the device 1004. The sample carriers 1014 may correspond to the sample carrier devices 224a, 224b and/or to the sample carrier device 104.

The device 1004 further includes one or more sample covers 1011, such as the sample cover 302 or the sample cover 106. The device 1004 may include a sample cover for more than one sample carrier device, In some implementations, each sample cover is independently controlled by the computing device 1006. Thus, sample carrier devices of the sample carriers 1014 may be exposed to an environment according to individualized conditions.

The device 1004 further includes actuators 1016. The actuators 1016 include one or more motors, one or more gears, one or more stepper motors, one or more other actuators, or a combination thereof. The actuators 1016 may correspond to the motor and gears 416a, 416b, 416c, to the stepper motors 412a, 412b, 412c, or a combination thereof. The actuators 1016 are configured to manipulate the cameras 1012, the sample carriers 1014, sample covers, or a combination thereof responsive to commands from the computing device 1006.

The device 1004 further includes one or more sensors 1018. The one or more sensors 1018 may correspond to the sensor 112. The one or more sensors includes one or more UV sensors, one or more radiation sensors, one or more temperature sensors, one or more other sensors or a combination thereof. In some implementations, the sensors 1018 includes a sensor package for each of the sample carriers 1014. For example, the sensors 1018 may include a first UV sensor, a first radiation sensor, and a first temperature sensor configured to generate sensor data related to a first sample carrier of the sample carriers 1014 and may further include a second UV sensor, a second radiation sensor, and a second temperature sensor configured to generate sensor data related to a second sample carrier of the sample carriers 1014. Sensor data generated by the sensors 1018 is stored in the memory device 1008 responsive to a command from the computing device 1006 in some implementations.

The external system 1002 further includes a transceiver 1020. In some implementations, the transceiver 1020 is replaced with discrete transmitter and receiver units. The transceiver 1020 may correspond to a transceiver of the vehicle 200. The external transceiver 1020 is configured to receive signals from and transmit signals to remote devices (e.g., a remote command station). Signals received from remote devices by the transceiver 1020 may be accessed or sent to the computing device 1006 for processing. Similarly, the computing device 1006 may access the transceiver 1020 to transmit signals to remote devices.

The external system 1002 further includes a power supply 1022. The power supply 1022 includes a battery, a photovoltaic panel, a radioisotope thermoelectric generator, another type of power supply, or a combination thereof. The power supply 1022 may include the photovoltaic panel 204 and the battery of the vehicle 200. Device 1004 is configured to draw power from the power supply 1022.

In operation, the computing device 1006 executing the characterization instructions 1024 is configured to generate image and sensor data of samples carried in the sample carriers 1014 using the cameras 1012 and the sensors 1018, as described herein, and to transmit the image and sensor data via the transceiver 1020.

Referring to FIG. 11, a block diagram illustrating a device 1100 for environmental factor interaction characterization is shown. The device 1100 corresponds to a modified version of the device 1004 in which the device 1100 includes an internal power supply 1104 and an internal transceiver 1102.

In this description, the term “couple” or “couples” means either an indirect or direct wired or wireless connection. Thus, if a first device couples to a second device, that connection may be through a direct connection or through an indirect connection via other devices and connections. The recitation “based on” means “based at least in part on.” Therefore, if X is based on Y, X may be a function of Y and any number of other factors.

Modifications are possible in the described embodiments, and other embodiments are possible, within the scope of the claims. While the specific embodiments described above have been shown by way of example, it will be appreciated that many modifications and other embodiments will come to the mind of one skilled in the art having the benefit of the teachings presented in the foregoing description and the associated drawings. Accordingly, it is understood that various modifications and embodiments are intended to be included within the scope of the appended claims. For example, various methods and operations described herein may be performed individually or in combination by devices other than those depicted. Further, aspects of the various examples illustrated and described herein may be combined.

What is claimed is:

1. An apparatus comprising:
a housing;
a sample carrier device, including one or more samples, mounted in the housing such that the one or more samples are external to the housing;
a sample cover mounted to the housing such that the sample cover and the housing enclose the sample carrier device;
a sensor directed to the sample carrier device;
a processor; and
a memory device storing instructions executable by the processor to:
initiate removal of the sample cover from the sample carrier device; and
initiate capture of data by the sensor.

2. The apparatus of claim 1, further comprising a second sample carrier device, including one or more second samples, mounted in the housing such that the one or more second samples are external to the housing and unenclosed by the sample cover.

3. The apparatus of claim 2, wherein the sensor is further directed to the second sample carrier device.

4. The apparatus of claim 2, further comprising a second sensor directed to the second sample carrier device.

5. The apparatus of claim 1, wherein the sensor comprises a camera.

6. The apparatus of claim 5, wherein the camera is located within a camera enclosure mounted on an external surface of the housing.

7. The apparatus of claim 6, further comprising:
a second camera located within the housing and directed to the sample carrier device, wherein the instructions are further executable by the processor to:
initiate capture of a second image of the sample carrier device by the second camera.

8. The apparatus of claim 6 further comprising an actuator, configured to drive the sample carrier device and move a sample of the sample carrier device within the camera enclosure responsive to a command from the processor.

9. The apparatus of claim 1, wherein the sensor comprises an ultraviolet sensor, a radiation sensor, or a combination thereof.

10. The apparatus of claim 1, wherein the sensor comprises a spectrometer.

11. The apparatus of claim 1, wherein the instructions are executable by the processor to initiate removal of the sample cover from the housing in response to receiving a command from a remote control station.

12. The apparatus of claim 1, wherein the instructions are executable by the processor to initiate removal of the sample cover from the housing in response to detecting an environmental condition.

13. The apparatus of claim 1, further comprising a motor, wherein initiating removal of the sample cover from the housing includes activating the motor to drive the sample cover from the housing.

14. The apparatus of claim 1, further comprising a lighting device configured to project light onto the sample carrier device.

15. The apparatus of claim 1, wherein the instructions are further executable by the processor to initiate movement of the sample cover to enclose the sample carrier device.

16. A method comprising:
initiating, at an apparatus including a sample carrier device, removal of a sample cover from the sample carrier device, wherein the sample carrier device includes samples and is mounted in a housing such that the samples are external to the housing; and
initiating capture of sensor data associated with the sample carrier device by a sensor directed to the sample carrier device.

17. The method of claim 16, wherein the sensor includes a camera, and wherein the data includes image data.

18. A computer readable storage device storing instructions executable by a processor to:
initiate, at an apparatus including a sample carrier device, removal of a sample cover from the sample carrier device, wherein the sample carrier device includes samples and is mounted in a housing such that the samples are external to the housing; and
initiate capture of sensor data associated with the sample carrier device by a sensor directed to the sample carrier device.

19. The computer readable storage device of claim 18, wherein the sensor includes an ultraviolet sensor, a radiation sensor, or a combination thereof directed to the sample carrier device.

20. The computer readable storage device of claim 18, wherein the sensor includes a camera directed to the sample carrier device.
